(19) United States
(12) Patent Application Publication
(10) Pub. No.: US 2022/0067122 A1
(43) Pub. Date: Mar. 3, 2022

(54) SYSTEM AND METHOD FOR CAPPING OUTLIERS DURING AN EXPERIMENT TEST

(71) Applicant: COUPANG CORP., Seoul (KR)

(72) Inventors: Qian WENG, Palo Alto, CA (US); Jun YE, Fremont, CA (US); Beibei YE, Fremont, CA (US)

(21) Appl. No.: 17/003,218

(22) Filed: Aug. 26, 2020

(51) Int. Cl. G06F 17/18; G06Q 30/02

(52) U.S. Cl. CPC G06F 17/18; G06Q 30/0204; G06Q 30/0201

(57) ABSTRACT

A computer-implemented systems and methods for capping outliers during an experiment test is disclosed. The computer implemented system comprises a memory storing instructions and at least one or more processors. The at least one or more processors may be configured to configured to execute the instructions to determine at least two groups of users comprising a plurality of users; obtain metric data related to each of the plurality of users; calculate a first value and a second value based on the metric data; identify an occurrence of a trigger event, using the metric data, the first value, and the second value; distribute the metric data into capped data and uncapped data and determine a threshold for the capped data; calculate a third value for the capped data and the uncapped data; determine if the capped data threshold has changed based on the third value; and implement at least one capping percentile value upon occurrence of the trigger event.

### TECHNICAL FIELD

The present disclosure generally relates to computerized systems and methods for analysis of data where outlier elements are detected and removed from the data during an experiment test. In particular, embodiments of the present disclosure relate to inventive and unconventional systems and methods for capping outliers during the experiment test.

### BACKGROUND

Many order fulfillment companies utilize A/B testing to understand the behavioral patterns of their customer in order to maximize their profit. Specifically, order fulfillment companies may utilize A/B testing on their webpages to understand how their customers respond to changes in specific elements on their webpages. Thus, multiple versions of a webpage with variations with the forms and visual impressions of certain elements are utilized to measure the performance of those variations. A/B testing may allow order fulfillment companies to construct hypotheses and learn better why certain elements positively or negatively impact customers' behaviors. Understanding the reaction of customers may lead to the webpage being designed to maximize profits by attracting customers that positively respond to the changes of the webpage.

While running an A/B test, one of the most important questions is which variation is performing better. However, a sudden deviation in customer behaviour may severely impact the variation's success or failure. Detecting and removing outlier data in a data-driven model is important to ensure that a representative and fair analysis is developed from the underlying data.

Currently, capping outliers is an important task while performing A/B testing and there are multiple strategies for dealing with outliers in the data. However, current implementations merely detect outliers using one metric after obtaining all the data. It is important to deal with outliers, in real time, because huge deviations in customer behavior may lead to unintended consequences in A/B testing and further during optimization.

Therefore, there is a need for improved methods and systems for objectively monitoring and removing outlier data in real time, for multiple metrics, using a dynamic process useful for data quality operations, data validation, data mining, data analysis, statistical modeling, mathematical calculations, etc. within the test environment.

### SUMMARY

One aspect of the present disclosure is directed to a computer-implemented system for capping outliers during a test, the system comprising: a memory storing instructions; and at least one or more processors configured to execute the instructions to perform steps comprising: determining at least two groups of users comprising a plurality of users; obtaining metric data related to each of the plurality of users; calculating a first value and a second value based on the metric data; identifying an occurrence of a trigger event, using the metric data, the first value, and the second value; distributing the metric data into capped data and uncapped data and determining a threshold for the capped data; calculating a third value for the capped data and the uncapped data; determining if the capped data threshold has changed based on the third value; and implementing at least one capping percentile value upon occurrence of the trigger event.

Another aspect of the present disclosure is directed to a method for capping outliers during a test, the method comprising: determining at least two groups of users comprising a plurality of users; obtaining metric data related to each of the plurality of users; calculating a first value and a second value based on the metric data; identifying an occurrence of a trigger event, using the metric data, the first value, and the second value; distributing the metric data into capped data and uncapped data and determining a threshold for the capped data; calculating a third value for the capped data and the uncapped data; determining if the capped data threshold has changed based on the third value; and implementing at least one capping percentile value upon occurrence of the trigger event.

Yet another aspect of the present disclosure is directed to a computer-implemented system for capping outliers during a test, the system comprising: a memory storing instructions; and at least one or more processors configured to execute the instructions to perform steps comprising: determining at least two groups of users comprising a plurality of users; obtaining metric data related to each of the plurality of users, wherein the metric data comprises one or more of page views, product views, and spending during a test period for each of the plurality of users collected from an e-commerce website; calculating a first value and a second value based on the metric data; determining a sample size of users in each of the at least two groups for which the metric data is obtained; determining that the sample size of users in at least two groups is greater than a predetermined threshold. determining whether a first condition is satisfied using the first value; determining whether a second condition is satisfied using the first value and the second value; and implementing at least one capping percentile value based on the sample size and the first condition or the second condition.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a block diagram illustrating an exemplary system for capping outliers during an experiment test, consistent with the disclosed embodiments.

FIG. 4 a flow chart of an exemplary method of capping outliers during an experiment test, consistent with the disclosed embodiments.

FIG. 5 is a flow chart of an exemplary method of determining conditions for implementing capping during an experiment test, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured to specifically perform capping of outliers of an active A/B test or design of experiment test being conducted on a webpage. As discussed in the embodiments below, extreme data handling can be used to quantitatively and qualitatively assess the data set based on a covariance of uncapped dataset, as compared to the covariance of capped dataset comprised of data values capped using an appropriate percentile. In some embodiments where there are possible extreme values, these extreme values may have high variance and therefore low test sensitivity. In such situations, it is easier to have false negative errors, i.e., failure to detect true difference between different test groups. In some situations, extreme values may be unevenly distributed across different test groups and may lead to false positives, i.e., results may show drastic difference between two test groups, while the difference is caused merely because of the samples collected rather than the actual test. In such situations, capping may be applied for cumulative daily updates which enables the system to quickly calculate percentile data and account for outliers without re-counting and re-calculating the entire data set each time. This significantly reduces the amount of processing power and computational burden and represents a significant improvement over current systems.

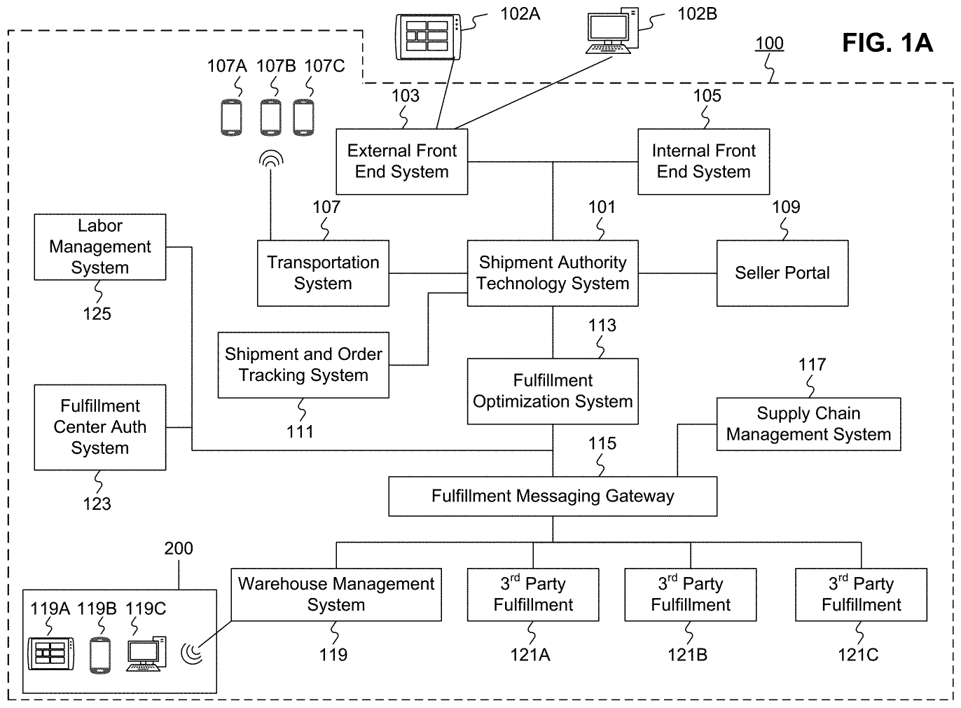

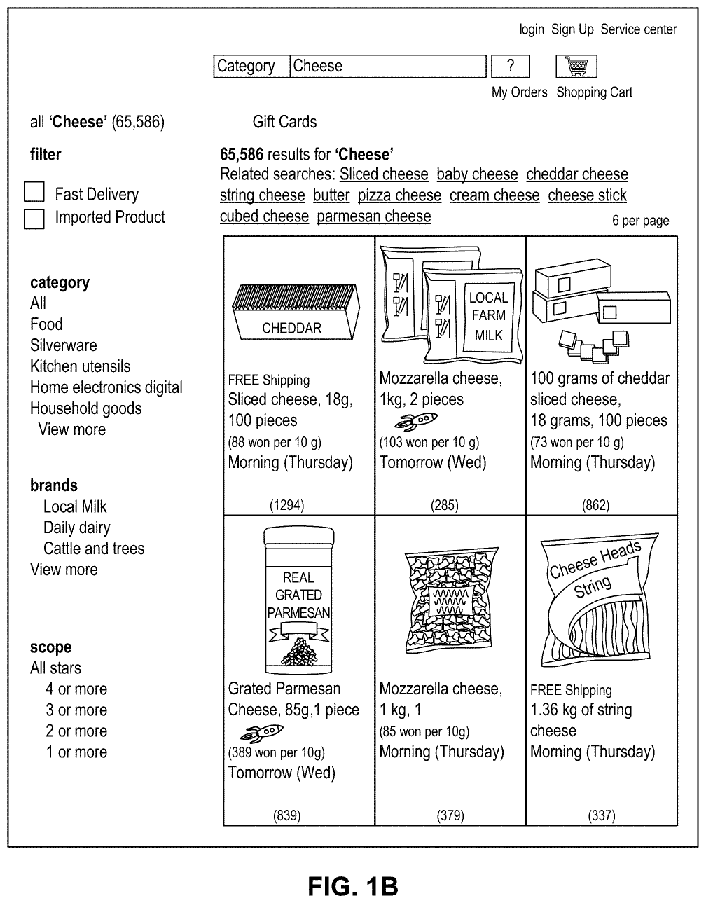

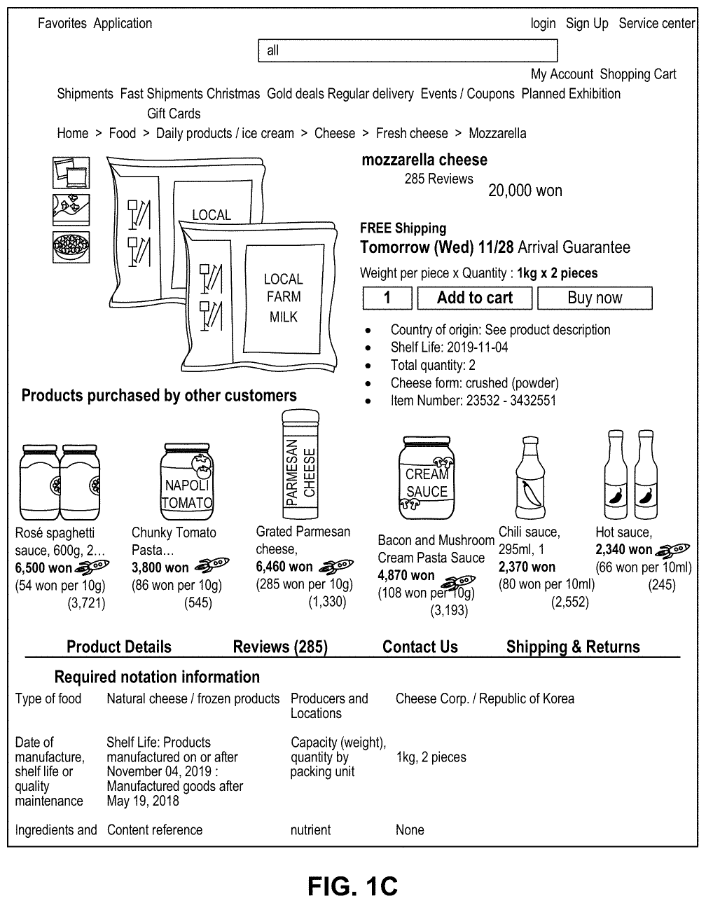

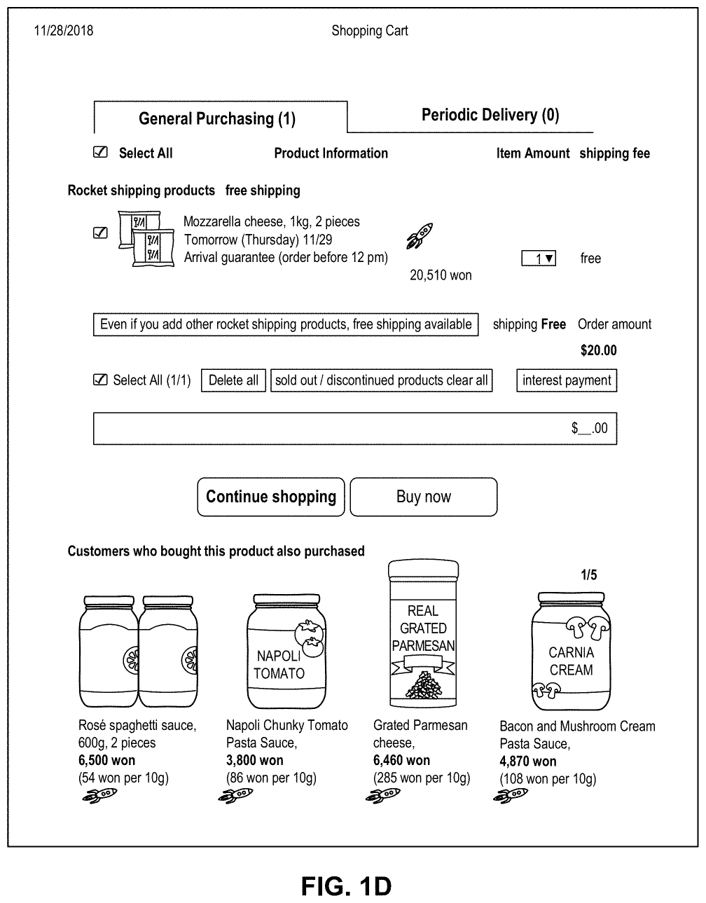

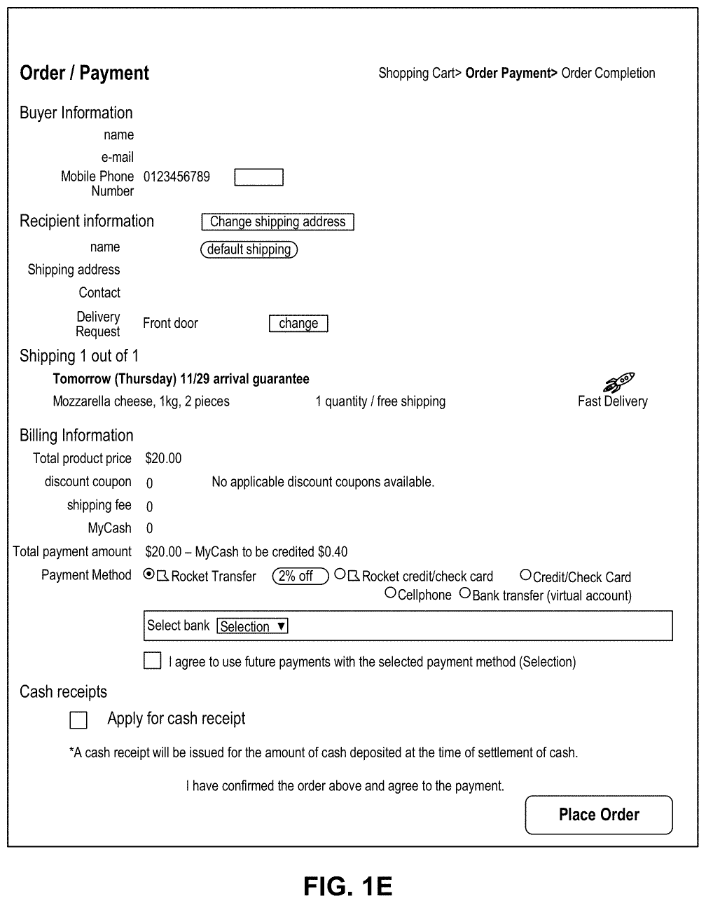

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

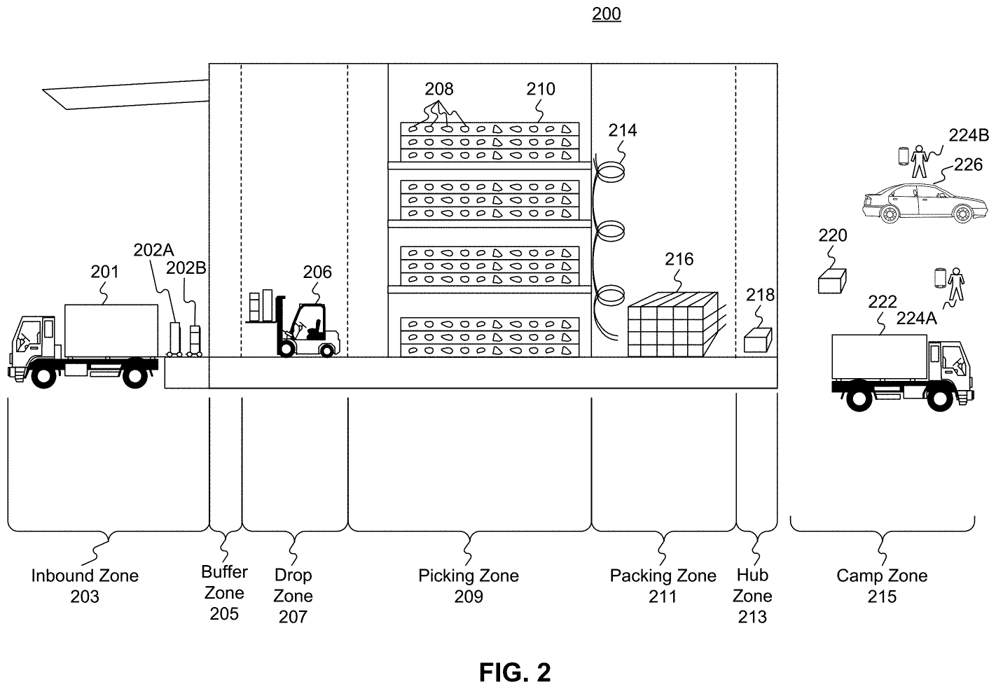

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 2028. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

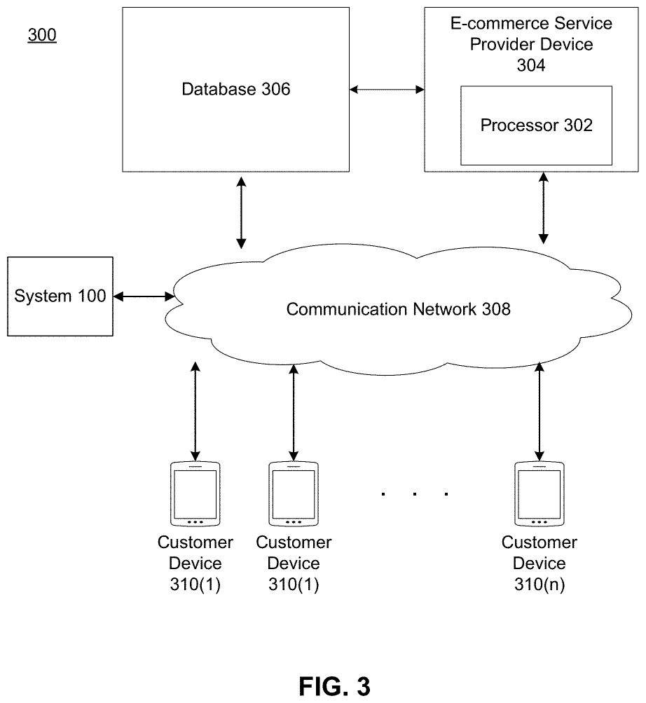

FIG. 3 is a block diagram of an exemplary system 300, for performing one or more operations consistent with disclosed embodiments. In some embodiments, system 300 includes one or more customer devices 310(1) . . . 310(n(n), an e-commerce service provider device 304, a database 306 and a communication network 308. The system 300 may also include a plurality of e-commerce service provider devices 304 (not shown in drawings), and a plurality of databases 306 (not shown in drawings) communicating with each other directly and further communicating with the customer devices 310(1)-310(n), via the communication network 308. The components and arrangement of the components included in system 300 may vary. Thus, system 300 may include other components that perform or assist in the performance of one or more operations consistent with the disclosed embodiments.

Customer devices 310(1)-310(n), e-commerce service provider device 304, and database 306 may include one or more computing devices (e.g., computer(s), server(s), etc.), memory storing data and/or software instructions (e.g., database(s), memory devices, etc.), and other known computing components. In some embodiments, the one or more computing devices may be configured to execute software instructions stored in the memory to perform one or more operations consistent with the disclosed embodiments. Aspects of customer device(s) 310(1)-310(n), device 304, and database 306 may be configured to communicate with one or more other components of system 100 via communication network 308, for example. In some embodiments, customer device(s) 310(1)-310(n) may be connected to external front end system 103 of system 100. In certain aspects, customers operate customer devices 310(1)-310(n), interact with one or more components of system 300 by sending and receiving communications, initiating operations, and/or providing input for one or more operations consistent with the disclosed embodiments.

E-commerce service provider device 304 may be associated with an entity that receives, processes, manages, or otherwise offers ordering services for items. Such an entity may be an e-commerce website used to buy items and get them delivered by customers associated with customer devices 310(1)-310(n). For example, the items that may be ordered via the entity may include prepared food, groceries, electronics, furniture, books, computers, and/or clothes, although any other type of items may also be ordered. For example, device 304 may receive order requests from customers using customer devices 310(1)-310(n) and process the received order requests to ship items ordered in the order request to the customers associated with the order request.

Database 306 of system 300 may be communicatively coupled to device 304 directly or via communication network 308. Further, the database 306 of system 300 may be communicatively coupled to customer devices 310(1)-310(n), and e-commerce service provider device 304 via the communication network 308. Database 306 may include one or more memory devices (not shown) that store information and are accessed and/or managed by one or more components of system 300. By way of example, database 306 may include Oracle™ databases, Sybase™ databases, or other relational databases or nonrelational databases, such as Hadoop sequence files, HBase, or Cassandra. Database 306 may include computing components (e.g., database management system, database server, etc.) (not shown) configured to receive and process requests for data stored in memory devices of database 306 and to provide data from database 306. In another embodiment, device 304 may store database 306 locally within it.

Database 306 is configured to store, among other things, metric data, customer profile information, inventory information, revenue information, logistics and shipping related information, etc. For example, customer profile information in database 306 may include customer name, customer home address, customer photos, and/or customer phone number, although any other type of information associated with the merchant can also be included.

Database 306 may store metric data. In some embodiments, metric data may be any data related to customer interaction with a website. In some embodiments, metric data may comprise one or more of customer interaction data, including total spending of the customer during a test period, number of webpage views during the test period, type of device used by the customer to access the webpage, etc. Customer interaction data, may include, for example, a number of times the customer has visited a webpage on a specific day, a number of times the customer visited a website during a specific time frame or date range, a number of times the customer has visited a website on a specific day, a number of times the customer visited a webpage during a specific time frame or date range, a number of times the customer has viewed a product or products, a number of times the customer has purchased a product or products, an amount of money spent by the customer on a specific product or products, an amount of money spent by the customer on a specific day, an amount of money spent by the customer during a specific time frame or date range, a number of times the customer has posted reviews for a product or products, a total spending per customer during a specific time frame or date range, an average spending per customer during a specific time frame or date range, a number of times the customer has visited a webpage on a specific day, a type of device used by the customers, etc.

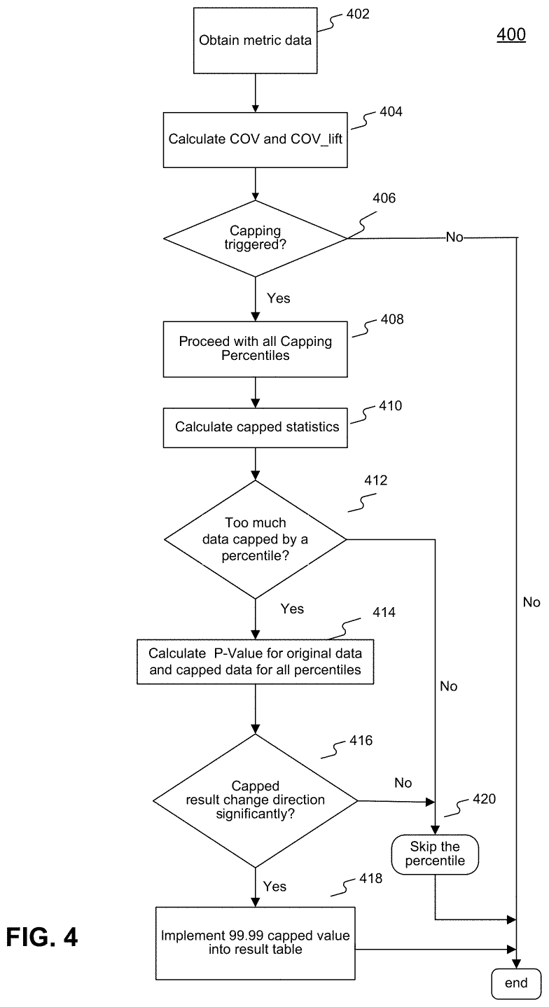

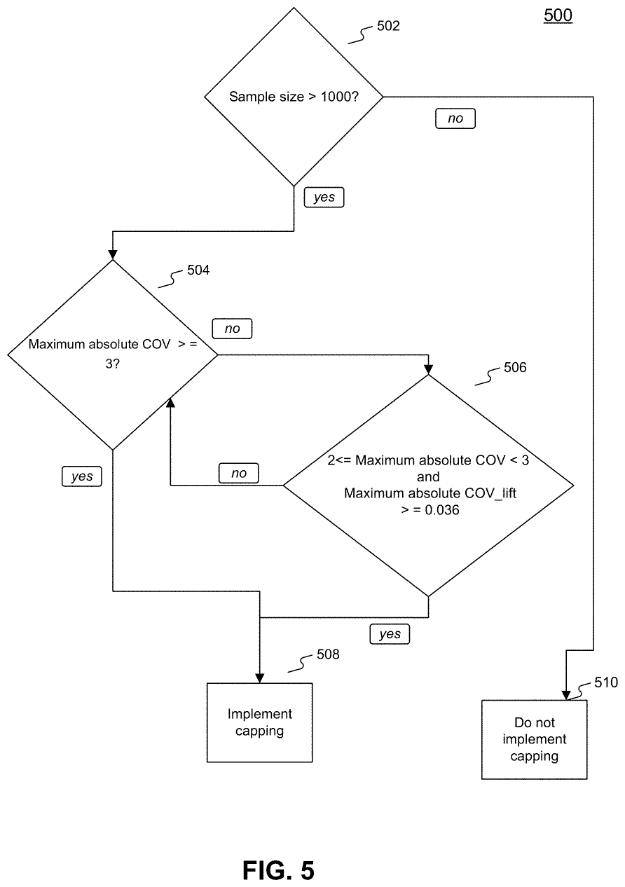

In one aspect, device 304 may include one or more computing devices, configured to perform one or more operations consistent with disclosed embodiments. In one aspect, device 304 may include one or more servers or server systems. Device 304 may include one or more processor(s) 302 configured to execute software instructions stored in a memory or other storage device. Processor 302 may be configured to execute the stored software instructions to perform network communication, online order-based processes of e-commerce calculations and processes related to capping outliers, etc. The one or more computing devices of device 304 may be configured to store customer metric data. The one or more computing devices device 304 may also be configured to communicate with other components of system 300 to receive and process order requests. In some embodiments, device 304 may provide one or more mobile applications, web-sites, or online portals that are accessible by customer devices 310(1)-310(n) over communication network 108. The metric data obtained from customer devices 310(1)-310(n) may be used by processor 304 to calculate capping statistics including, p-values, sample sizes, standard deviation, covariance data, capping percentiles, conditions that may trigger capping, capping thresholds, etc., for one or more of the metric data as explained in detail below with reference to FIGS. 4 and 5. The disclosed embodiments are not limited to any particular configuration of e-commerce service provider device 304.

Communication network 308 may comprise any type of computer networking arrangement configured to provide communications or exchange data, or both, between components of system 300. For example, communication network 308 may include any type of network (including infrastructure) that provides communications, exchanges information, and/or facilitates the exchange of information, such as the Internet, a private data network, a virtual private network using a public network, a LAN or WAN network, a Wi-Fi™ network, and/or other suitable connections that may enable information exchange among various components of system 300. Communication network 308 may also include a public switched telephone network (“PSTN”) and/or a wireless cellular network. Communication network 108 may be a secured network or unsecured network. In some embodiments, one or more components of system 300 may communicate directly through a dedicated communication link(s).

Customer devices 310(1)-310(n) may be one or more computing devices configured to perform one or more operations consistent with the disclosed embodiments. Customer devices 310(1)-310(n) may execute browser or related mobile display software that displays an e-commerce website for placing orders for delivery of items, receiving orders and delivering items that are ordered, on a display included in, or connected to, customer devices 310(1)-310(n). Customer devices 310(1)-310(n) may also store and execute other mobile applications that allow customers to interact with a website interface provided by device 304.

In some embodiments, the devices in system 300 may be a part of system 100. In other embodiments, system 300 may be a separate system which can be used in combination with system 100 to perform the methods consistent with the disclosed embodiments. The active A/B test or design of experiment test may be conducted on device 304 after collecting metric data from customer devices 310(1)-310(n), where customers are interacting with a website or a mobile application. Data regarding the active A/B test or design of experiment test may be recorded and used by device 304 to perform the processes consistent with the disclosed embodiments. Device 304 may also be configured to acquire the data from Internal Front End System 105 of system 100. The data obtained by e-device 304 may also include customer specific metric data. The data obtained from front end system 105 may also be used by processor 304 to calculate capping data including, statistics, p-values, sample sizes, covariance data, capping data, capping percentages, capping conditions, capping thresholds, etc.

In some embodiments in which A/B testing is performed, a first test variant may include an existing version of the website or mobile application, while a second test variant may include one or more modifications to the website of mobile application for improved customer experience. For example, an existing version of the website or mobile application may include a first feature or set of features, for e.g., visual, audio, tactile, or other user interactive content. An experimental version of the website may include a second feature or set of features different from the existing version. These features may be related to customer interactions with the website or mobile application, such as the location of the content for customers to interact, or color of an interface that may be used to purchase a product, i.e. different webpage design, different layouts, different products displayed for different customers, different discounts based on customer interactions, etc. An A/B test may be used to determine one or more metrics associated with both versions of the website. The metric(s) determined by the A/B test may include a quantity or percentage of customers that view or interact with a link, advertisement, or product, customers that purchase a product, customers that view multiple products, comment on purchased products, review purchased products, and so forth, for each tested feature or set of features.

FIG. 4 is a flow chart of an exemplary method 400 for capping outliers during an experiment test, consistent with the disclosed embodiments. The steps of method 400 may be performed by processor 302. At step 402, system 300 may obtain metric data from system 100 and store it in database 306. In some embodiments, metric data (also referred as customer interaction data) may be determined using cookies, address information of the customer (i.e. an IP or MAC address), or whether the customer has registered with the website, etc. For example, if the website or mobile application supports cookies and cookies are enabled, every subsequent request to the website may include the cookie. The use of cookies may allow an e-commerce web server, such as e-commerce service provider device 304, to track particular actions and status of the customers over multiple sessions. Cookies are generally implemented as files stored on the customer's device that indicate the customer's identity or other information required by many web sites. Cookies may include information such as login or registration data, user preference data, or any other information that a server host sends to a customer's web browser for the web browser to return to the server at a later time. In some embodiments, additional information may be collected about a particular customer. For example, additional information may include information relating to the customer's demographics, geographic location (e.g., based on a GPS in a mobile device, IP address, etc.), system information (e.g., web browser, the type of computing device, etc.), and any other type of metric data related to the customer's interaction with the website or mobile application.

The steps of method 400 may be performed in real time using current metric data. Current metric data may comprise of customer interaction data collected during the test period for the different test options. The test period may be a number or hours or days during which the experiment test is performed. In some embodiments, the test period may be a couple of days, while in other embodiments, it may a couple of weeks, such as during a holiday where many people purchase products online. In such a situation, the test period may be 5 days, beginning from Thanksgiving Day (Thursday) to Cyber Monday (the following Monday). It may be important for online sellers to understand customer behaviour, for example, the amount spent by the customers, the number of products and type of products purchased by the customers, delivery requirements of the customers, number of customers accessing the website, etc. during this period. This data may be used for website performance and load management, revenue management, inventory management, warehouse management, shipping e.g., speed/method of delivery and/or pickup, transportation, and logistics management, etc.

Additionally or alternatively, steps of method 400 may be performed on historical metric data. In some embodiments, the historical metric data may comprise data collected during prior customer interactions with the website or mobile application. For example, historical metric data may comprise of customer interaction data collected in previous couple of years during the thanksgiving holidays. Historical metric data may be stored in database 306. The historical metric data may have been used to previously conduct A/B testing. Historical test data may comprise of results of the previously conducted tests, using the historical metric data. Historical test data may be used to obtain certain parameters for the real-time A/B testing. For example, a sample size may be determined using historical metric data and historical test data. Too big sample size or too small sample size both may have limitations that may compromise the conclusions drawn from the test. Too small a sample may prevent the findings from being extrapolated, whereas too large a sample may amplify the detection of differences, emphasizing statistical differences that are not relevant. Sample size is an important consideration during experiment test and historical metric data and historical test data may prove useful in determining the sample size for future testing.

In some embodiments, sample size may be determined using historical test data that may provide accurate mean value and identify outliers with a smaller margin of error. For example, a specific metric, for e.g. the total amount spent, may be obtained for each customer using the metric data. An average of the total amount spent may be determined as an arbitrary metric which may be set to a desired value (β). The desired value (β) of the arbitrary metric may be set such that it correlates to improved business. In some embodiments, a minimum sample size “n” may be calculated, which when used for A/B testing of the specific metric, will attain the desired value (β) for the arbitrary metric. In some examples, minimum sample size (n) may be 1000. The intent of using a specific sample size is to collect enough data points to confidently make predictions or changes based on results of the tests conducted using that sample size. First, a sample size “m” may be considered, and the total amount spent may be obtained for “m” samples. This process may be repeated multiple times to obtain an empirical estimate of the sampling distribution under a null hypothesis. In some embodiments, the sampling may be repeated with sample size (m) shifted by an offset (A) and an estimate may be obtained using the sampling distribution under an alternative hypothesis using sample size (m+Δ) or (m−Δ). Using multiple offset values (A) and repeating the procedure in an optimization loop, a minimum sample size “n” required to attain the desired value (β) for the arbitrary metric may be obtained. In some embodiments, method 400 may be used at a metric level to indicate if a specific metric, for example, average order value or revenue per customer during the testing period, includes outliers and needs capping. Outliers are values that are notably different from other data points. In other words, they may be unusual values in a dataset. Outliers are problematic for many statistical analyses because they can cause tests to either miss significant findings or distort real results.

In other embodiments, method 400 may be implemented for multiple metrics and multiple test options or test groups. Multiple users may split into multiple test groups in order to conduct A/B testing. Multiple test groups are compared using a single metric or multiple metrics, typically by testing the customer's response to for example, group A against group B, and determining which of the two groups is more effective. Method 400 may be implemented for one single metric across multiple test groups or for multiple metrics across multiple test groups. In some embodiments, a test experiment may include a test group A and test group B. Processor 302 may be configured to divide the customers into different test groups. Processor 302 may further be configured to implement different versions of a website to show different features to different test groups. For example, processor 302 may be configured to expose customers of test group A to version A of the website. Version A may show an existing webpage on an e-commerce website for selling a shoe including a single image of the shoe. Processor 302 may also be configured to expose customers of test group B to version B of the website. Version B may be a different variant of the same e-commerce website, which may show an existing webpage on an e-commerce website for selling a shoe including multiple images of the shoe from various angles.

At step 404, processor 302 uses the metric data to calculate a first value, i.e. COV and a second value, i.e. COV_lift. COV is the coefficient of variation represented by COV=σ/μ, which measures relative variability of the metric as the ratio of the standard deviation of the metric to the mean of the metric. Processor 302 may calculate the COV a single metric across multiple test groups. For example, processor 302 may calculate the COV for amount of money spent by customers of group A and amount of money spent by customers of group B during the test period. In this case, processor 302 may calculate COV for amount of money spent by customers of group A as the ratio of standard deviation of amount of money spent by customers of group A to the mean amount of money spent by customers of group A. Processor 302 may calculate the COV for multiple metrics across multiple test groups. For example, processor 302 may calculate the COV for an amount of time spent on the website by customers of group A and group B and the amount of money spent by customers of group A and group B buying shoes on the website during the test period. The second value, COV_lift, is the difference of covariance between two different test groups, where the COV_lift is defined as a percentage. For example, processor 302 calculates a difference between COV calculated for amount of money spent by customers of group A and COV calculated for the amount of money spent by customers of group B during the test period. This difference is represented by COV_lift. Processor 302 may use COV and COV_lift to determine if there is a possibility of extreme values within the metric data.

At step 406, processor 302 uses the COV and COV_lift values to determine if a trigger event occurs, i.e. if capping should be triggered. For example, the higher the COV, the higher chance there is of having extreme values within the data. Processor 302 may determine a maximum value i.e. max(COV) from the calculated COV values across multiple test groups. Processor 302 may determine a maximum value of COV per metric i.e. max(COV) for each metric across multiple test groups. In some embodiments, processor 302 may determine max(COV) for each metric across both the test groups, test group A and test group B. Max(COV) may represent the maximum value per metric among all the multiple test groups for which the COV is calculated. For example, in some embodiments max(COV) may the maximum value of COV calculated for amount of money spent by customers across both test group A and test group B.

In some embodiments, processor 302 may determine a first predetermined threshold or upper maximum COV, a second predetermined threshold or lower maximum COV and a third predetermined threshold or max(COV_lift). Upper maximum COV may be defined as the highest value of max(COV) for a metric across multiple test options, lower maximum COV may be defined as the lowest value of max(COV) obtained for a metric across multiple test options and max(COV_lift) may be defined as the highest value of COV_lift for a metric across multiple test options. In some embodiments, processor 302 may determine the upper maximum COV, lower maximum COV and max(COV_lift) objectively from empirical evaluation of the historical test data by making an assumption that the current metrics are similar to the historic metrics. Historical test data may comprise of the results of experimental tests previously conducted, using the historical metric data. Processor 302 may obtain max(COV) for each metric from the historical test data collected across multiple experiment tests previously conducted. Processor 302 may determine multiple values for upper maximum COV, lower maximum COV and max(COV_lift) and may select the thresholds with low percentage of false positives. In some embodiments, processor 302 may determine multiple values for upper maximum COV, lower maximum COV and max(COV_lift) and may select the thresholds using historical test data including a data set where there are known outliers.

Processor 302 may determine whether the max(COV) per metric for each of the test group A and test group B is above or below or equal to a first predetermined threshold or upper maximum COV In some embodiments, the first predetermined threshold may be, for example, 3 (in which case processor 302 may determine if max(COV)>=3). If processor 302 determines that the max(COV) for a metric, for example, the metric amount of money spent by customers, is greater than or equal to the first predetermined threshold, for example, 3, for either one of group A or group B, then capping may be triggered.

In some embodiments, processor 302 may determine that the max(COV) for per metric for each of the test group A and test group B is below the first predetermined threshold, for example, 3. In such a situation, processor 302 may further determine if max(COV) is greater than a second predetermined threshold or lower maximum COV. In some embodiments, the second predetermined threshold is 2. I.e. processor 302 may determine if, 2<=max(COV)<3. Processor 302 may further determine maximum value of COV_lift per metric, i.e., max(COV_lift) for each of the test group A and test group B. Processor 302 may determine whether the max(COV_lift) per metric for each of the test group A and test group B is greater than or equal to a third predetermined threshold or max(COV_lift). In some embodiments, the third predetermined threshold is 0.036. If processor 302 determines that max(COV) per metric for either one of the test groups, test group A or B is less than the first predetermined threshold, for example, 3 but greater than or equal to the second predetermined threshold, for example, 2, and max(COV_lift) per metric for both test groups A and B is greater than or equal to the third predetermined threshold, for example, 0.036, then capping may be triggered for that metric.

If, at step 406, it is determined that capping is triggered (YES), processor 302 proceeds with capping data for a single metric or for multiple metrics for all test groups. Processor 302 proceeds to step 408 where it implements capping for all percentiles, where a percentile creates a capped data range with outliers trimmed or removed. In some embodiments, capping may be implemented for three different capping percentiles, for example, 99%, 99.9% and 99.99%. In some embodiments, the 99th percentile represents a subset of an original data set, with 0.5% of outliers capped from each side of its normal distribution, the 99.9th percentile represents a subset of the original data set, with 0.05% of outliers capped from each side of its normal distribution and the 99.99th percentile represents a subset of the original data set, with 0.005% of outliers capped from each side of its normal distribution. The original data set comprises of a sample size which represents a number of customers per test group. In some embodiments, processor 302 may determine at step 404 that capping has been triggered for one or more test groups for one metric. As discussed above, processor 302 may determine that capping has been triggered for both test group A and test group B for the metric, amount of money spent by the customer during the test period. Considering as an example, that the original data set has a sample size of 1000, the 99th percentile will remove the first 5 (minimum) values and the last 5 (maximum) values and use the remaining values as the capped data set. Similarly, the 99.9th percentile will remove the first 0.5 (minimum) and the last 0.5 (maximum) values and use the remaining values as the capped data set and the 99.99th percentile will remove the first the first 0.05 (minimum) and the last 0.05 (maximum) values and use the remaining values as the capped data set. All test groups may be treated with the same capping percentiles for different metrics during the test period.

At step 410, processor 302 calculates capping statistics for all percentiles. For example, processor 302 may calculate capping threshold, arithmetic averages etc. using the metric data, COV, and COV_lift for each percentile.

At step 412, processor 302 determines using the calculated capped statistics if too much data has been capped by a specific percentile. In some embodiments, processor 302 may calculate values for sum and sum_capped. Sum is defined as a sum of data collected for a metric for all customers before removing outliers and sum_capped is defined as a sum of data collected for a metric after removing outliers. For example, sum may be calculated by processor 302 as a sum of data collected for the metric, for e.g., average spending per customer for all customers, across multiple test options before removing outliers and sum_capped may be calculated by processor 302 as a sum of data collected for the metric, for e.g., average spending per customer for all customers, across multiple test option after removing outliers. For example, in some embodiments, for capping to be implemented, a ratio of sum_capped and sum must be greater than 95% for every percentile. If the ratio is greater than 95%, processor 302 may determine that too much data is capped. For example, in some embodiments, processor 302 may determine at step 410 that too much data has been capped for the 99th percentile, it may skip the 99.9th and the 99.99th percentiles and method 400 may proceed to step 414. In some embodiments, processor 302 may determine at step 410 that too much data has been capped for 99.9 percentile, it may skip 99.99 percentile and method 400 may proceed to step 414. In some embodiments, processor 302 may determine at step 410 that too much data has been capped for 99.99 percentile and the method may proceed to step 414. If too much data is not capped for any of the percentiles, i.e. the ratio is less than 95%, method 400 may proceed to step 420 to use uncapped data and capping may not be implemented.

When processor 302 determines at step 412 that too much data has been capped by either one of the percentiles (99.99, 99.9 or 99), method 400 proceeds to step 414. At step 414, p-value for the original data and p-value for capped data is calculated. P-value for capped data may be calculated for one or more of the 99.99, 99.9 or 99 percentiles.

In some embodiments, a p-value obtained from statistical tests may be used to decide whether the observed difference from an experiment may be caused by the different test groups or sample noise. A metric's p-value calculation may be based on the magnitude and the variance of the observed difference. For metrics with long tail distributions (i.e., metrics with possible extreme values), both the magnitude and variance of the observed difference may be easily affected by the tail. The effects of those extreme values on the test statistics may show that metrics with more extreme values may have high variance and therefore low test sensitivity. It may be harder to reach statistical significance and easier to have false negative errors, where false negative errors refer to the cases where there may be a failure to detect a true difference between the test groups. Extreme values may be distributed unevenly across different options and affect mean dramatically. This may lead to false positive, i.e., variations across different test groups, may be the result of the samples collected rather than the actual data. Processor 302 may simulate testing using the historical test data, to evaluate multiple parameters and set an acceptable rate of false positives. The hypothesis test may yield a p-value, which is the probability that a false positive may have occurred. In some embodiments, a p-value for example, 0.05 may be used as a threshold. Using 0.05 as the p-value threshold, processor 302 may determine that, the acceptable rate of false positives may be 5%.

In some embodiments, by triggering capping, the statistical significance conclusion (direction) change either from nonsignificant to significant or significant to nonsignificant may be determined. P-value of the uncapped data for every percentile may be pre-calculated to be 0.05, i.e. the best value for obtaining optimum results. At step 414, p-values may be calculated for capped data for each metric and each percentile. In some embodiments, if there is no significant difference between the p-value of the uncapped data and the capped data for any of the percentiles, i.e. there is no significant change in direction, method 400 may proceed to step 420 to use uncapped data and capping may not be implemented. On the contrary, if there is significant difference between the p-values of the capped data and the uncapped data, 99.99^{th} capping percentile may be implemented. Method 400 may proceed to step 418 and the results may be stored in a table in database 306. Further, at step 418, results for 99.9^{th} percentile and 99^{th} percentile may also be calculated and stored in a different table in database 306.

FIG. 5 is a flow chart of an exemplary method of determining conditions for implementing capping, consistent with the disclosed embodiments. In some embodiments, exemplary method 500 describes the method performed by processor 302, in step 406 of FIG. 4, to determine if capping may be triggered. Processor 302 uses the COV and COV_lift values to determine if a trigger event occurs, i.e. if capping should be triggered. As explained above, COV and COV_lift values may be calculated for each of the metrics for all the test groups. Flow chart of FIG. 5 shows three conditions which may result in capping. Step 502, step 504 and step 506 describe the conditions that must be satisfied to implement capping. Only if step 502 is satisfied, the process will move to check if step 504 or step 506 are being satisfied. For capping to be implemented, “step 502 (i)” AND “step 504 (ii) OR step 506 (iii)” needs to be satisfied. If i & (ii|iii) is true, there is a high chance of valid tail effect and capping should be triggered. At step 502, processor 302 determines if sample size of each of the test groups is greater than a predetermined threshold. The predetermined threshold may change based on the type of test being conducted and the required outcome. For example, in this embodiment, sample size may be predetermined to be 1000. If the sample size is less than 1000 for one of the metrics, then capping is not implemented for that metric (step 510). For example, if the sample size of the metric “average amount spent by customer” consists of merely 50 customers, and sample size of other metrics is greater than 1000, it may not be efficient to perform all the capping calculations for the “average amount spent by customer” metric. However, processor 302 may proceed with checking for the second condition and the third condition for the other metrics with sample size greater than 1000.

At step 504, processor 302 checks for the second condition, i.e. if max(COV) is greater than upper maximum COV, across all options. An absolute maximum point is a point where the function obtains its greatest possible value. Processor 302 is configured to calculate max(COV) as discussed above. Further, processor 302 may also be configured to obtain a COV threshold which indicates the starting point of the long tail distribution. Processor 302 may calculate a maximum value of COV per metric i.e. max(COV) for each of the test group A and test group B. Processor 302 may determine whether the max(COV) for per metric for each of the test group A and test group B is above or below or equal to a first predetermined threshold (upper maximum COV). In some embodiments, the first predetermined threshold is 3. I.e. processor 302 may determine if max(COV)>=upper maximum COV, for example, 3. If processor 302 determines that the max(COV) for a metric, for example, the metric amount of money spent by customers, is greater than or equal to the first predetermined threshold, for example, 3 for either one of group A or group B, then step 502 is satisfied. In some embodiments, processor 302 at step 502, may determine that the max(COV) for per metric for each of the test group A and test group B is below the first predetermined threshold or upper maximum COV. If it is determined that the max(COV) per metric for each of the test group A and test group B is below the first predetermined threshold, the process moves to step 506.

At step 506, processor 302 checks for the third condition. Processor 302 may determine if max(COV) is greater than a second predetermined threshold or lower maximum COV. For example, in some embodiments, the lower maximum COV may be predetermined to be 2. I.e. processor 302 may determine if, lower maximum COV, for example, 2<=max(COV)<upper maximum COV, for example, 3. Processor 302 may further determine maximum value of COV_lift per metric i.e. max(COV_lift) for each of the test group A and test group B.

Processor 302 may further determine whether the max(COV_lift) per metric for each of the test group A and test group B is greater than or equal to a third predetermined threshold or COV_lift_percent. For example, in some embodiments, COV_lift_percent may be predetermined to be 0.036. If processor 302 determines that max(COV) per metric for either one of the test groups, test group A or B is less than upper maximum COV, for example, 3 but greater than or equal to lower maximum COV, for example, 2, and max(COV_lift) per metric for both test groups A and B is greater than or equal to third predetermined threshold or COV_lift_percent, for example, 0.036, then capping may be triggered for that metric. At step 506, if processor 302 determines that the third condition is satisfied, process 500 proceeds to step 508 to implement capping for each metric and test group according to the method discussed above with reference to FIG. 4. If processor 302 determines that either one of the second or third conditions is satisfied along with the first condition, then capping is implemented in accordance to the method discussed above with reference to FIG. 4. If processor 302 determines that the first condition is satisfied but second and third conditions are not satisfied, then capping is not implemented.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for capping outliers during a test, the system comprising:
a memory storing instructions; and
at least one or more processors configured to execute the instructions to perform steps comprising:
determining at least two groups of users each comprising a plurality of users, wherein the number of the plurality of the users is based on results data of historical experiments;
obtaining metric data related to each of the plurality et users, wherein the metric data is based on current interactions of the plurality of users obtained for an experiment period;
calculating a first value and a second value based on the metric data;
identifying an occurrence of a trigger event, using the metric data, the first value, and the second value;
distributing the metric data into capped data and uncapped data and determining a threshold for the capped data;
calculating a third value for the capped data and the uncapped data;
determining if the capped data threshold has changed based on the third value; and
implementing at least one capping percentile value upon occurrence of the trigger event.

2. The system of claim 1, wherein a group of the at least two groups are determined based on a test experiment, the metric data being obtained from the test experiment.

3. The system of claim 1, wherein the at least one or more processors are further configured to perform steps comprising:
determining a sample size of users in each of the at least two groups for which the metric data is obtained; and
determining that the sample size of users in at least two groups is greater than a predetermined threshold.

4. The system of claim 1, wherein the at least one or n ore processors are further configured to perform steps comprising:
determining whether a first condition is satisfied using the first value:
determining whether a second condition is satisfied using the first value and the second value; and
determining that the trigger event has occurred based on a sample size and the first condition or the second condition.

5. The system of claim 1, wherein the capping percentile is selected based on at least one of three different capping percentiles.

6. The system of claim 1, wherein the metric data comprises one or more of page views, product views, and spending during the experiment period for each of the plurality of users collected from an e-commerce website.

7. The system of claim 1 wherein the at least one or more processors are further configured to calculate a fourth value for one or more of the metric data before capping.

8. The system of claim 1 wherein the at least one or more processors are further configured to use the uncapped data when the third value for the capped data and the uncapped data is within a predetermined range.

9. The system of claim 1, the at least one or more processors are further configured to calculate the first value for each of the metric data, wherein probability of outliers increases when the first value for each of the metric data is larger than a predetermined threshold for each metric data.

10. The system of claim 1, wherein the metric data is obtained in real time from a current interaction of each user of the plurality of users with a presentation of data on respective user devices.

11. A computer-implemented method for capping outliers during a test, the method comprising:
determining at least two groups of users each comprising a plurality of users, wherein number of users of the plurality of the users is based on results data of historical experiments;
obtaining metric data related to each of the plurality of users, wherein the metric data is based on current interactions of the plurality of users obtained for an experiment period;
calculating a first value and a second value based on the metric data;
identifying an occurrence of a trigger event, using the metric data, the first value, and the second value;
distributing the metric data into capped data and uncapped data and determining a threshold for the capped data; calculating a third value for the capped data and the uncapped data;
determining if the capped data threshold has changed based on the third value; and
implementing at least one capping percentile value upon occurrence of the trigger event.

12. The method of claim 11, wherein a group of the at least two groups are determined based on a test experiment, the metric data being obtained from the test experiment.

13. The method of claim 11, further the method comprising:
determining a sample size of users in each of the at least two groups for which the metric data is obtained;
determining that the sample size of users in at least two groups is greater than a predetermined threshold.

14. The method of claim 10, further the method comprising:
determining whether a first condition is satisfied using the first value;
determining whether a second condition is satisfied using the first value and the second value;
determining that the trigger event has occurred based on a sample size and the first condition or the second condition.

15. The method of claim 11, wherein the capping percentile is selected based on at least one of three different capping percentiles.

16. The method of claim 11, wherein the metric data comprises one or more of page views, product views, and spending during the experiment period for each of the plurality of users collected from an e-commerce website.

17. The method of claim 11, further comprising calculating a fourth value for one or more of the metric data before capping.

18. The method of claim 11, further comprising using the uncapped data when the third value for the capped data and the uncapped data is within a predetermined range.

19. The method of claim 11, further comprising calculating the first value for each of the metric data, wherein probability of outliers increases when the first value for each of the metric data is larger than a predetermined threshold for each metric data.

20.

21. The system of claim 1, wherein the length of the experiment period and the point in time of the experiment period are based on historical metric data.
